(19) United States
(12) Patent Application Publication
(10) Pub. No.: US 2004/0170741 A1
(43) Pub. Date: Sep. 2, 2004

(54) Compounds and their use in food compositions

(75) Inventors: Robertus Martinus Diks, Vlaardingen (NL); Ian Stewart Galloway, Essex (GB); Kevin John Povey, Berkshire (GB)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/626,451

(22) Filed: Jul. 24, 2003

(30) Foreign Application Priority Data
Jul. 26, 2002 (EP) 02255241.8

(51) Int. Cl. A23D 7/00

(52) U.S. Cl. 426/601

(57) ABSTRACT

Use of at least one compound selected from phytosterols, phytostanols, synthetic analogues thereof and their esterified derivatives as a creaminess enhancer in a food composition comprising a dairy product or derivative or analogue thereof.

### FIELD OF THE INVENTION

The present invention relates to plant derived compounds and analogues and derivatives thereof and their use in food compositions.

### BACKGROUND OF THE INVENTION

Various plant sterols and plant sterol derived compounds have (when consumed in the right form) a known and well-documented effect on blood cholesterol level. Among these are compounds like β-sitosterol, the hydrogenated form thereof (β-sitostanol), as well as esterified forms thereof. Sterols have been reported to be capable of lowering the level of blood cholesterol (Pollak & Kritchevsky, Monographs in Atherosclerosis, 1981). In particular, the group of 4-desmethylsterols, 4-monomethylsterols, their hydrogenated forms and fatty acid esters have been reported to have a beneficial effect on blood cholesterol level, in particular on LDL-cholesterol.

We have now found that compounds of the above type when used as additives in bulk dairy and non-dairy food products also enhance consumer perception of creaminess in the products.

WO-A-99/44442 and FR-A-2 775 620 disclose a manufacturing process for food products whereby a homogeneous emulsifier-free suspension of at least one hydrophobic and/or high melting point substance in an aqueous medium and a thickener can be prepared. The hydrophobic substance may be chosen from phytosterols, phytostanols and their esterified derivatives. The process is said to be particularly suited to manufacture of milk and milk derivative food compositions.

WO-A-00/33669 discloses liposome solutions with high emulsifier levels and containing plant sterols or plant stanols.

U.S. Pat. No. 2002/064,548 discloses non-dairy beverages comprising dispersions of plant sterols.

U.S. Pat. No. 2001/027,190 discloses low-fat, fat-free and triglyceride free compositions with sterols or sterol esters and which are mouthfeel enhancing, texture-building and composition stabilizing. This document states that richness and creaminess may be adversely affected by removal or reduction of fat. However, no creaminess property is attributed to the sterols or their esters.

U.S. Pat. No. 6,391,370 relates to preparation of plant sterol-emulsifier dispersions for incorporation into food products. One example described is a yoghurt product.

EP-A-1 212 945 discloses incorporation of stanol esters into various beverages, including milk-based beverages. Sterol esters are mentioned as possible alternatives to the stanol esters.

WO-A-98/19556 discloses use of fatty acid esters of sterols or stanols as texturising hardstock replacers in margarines, mayonnaises, cooking oils, cheeses, butter and shortenings.

DE-A-1 00 63 288 discloses fruit, vegetable, milk and/or wine mixed drinks containing phytosterols. There is a single example of a non-dairy orange drink which contains an emulsifier.

### DEFINITION OF THE INVENTION

In a first aspect, the present invention provides use of at least one compound selected from phytosterols, phytostanols, synthetic analogues thereof and esterified derivatives of any of the foregoing as a creaminess enhancer in a food comprising a dairy product or a derivative or analogue thereof.

The first aspect of the present invention may also be expressed as a method of enhancing the creaminess of a food comprising a dairy product or derivative or analogue thereof by adding to said product, a creaminess enhancer selected from phytosterols, phytostanols, synthetic analogues thereof and esterified derivatives of any of the foregoing.

In a broad conceptualisation, when expressed in terms of compositions, a second aspect of the present invention provides a food composition comprising a dairy product or a derivative or analogue thereof, an emulsifier and a creaminess enhancer selected from one or more of phytosterols, phytostanols, synthetic analogues thereof and esterified derivatives of any of these.

A third aspect of the present invention provides a food composition comprising a dairy product or derivative or analogue thereof, from 0.001 to 0.5%, preferably from 0.01% to 0.3% by weight of emulsifier, and a creaminess enhancer selected from one or more of phytosterols, phytostanols, synthetic analogues thereof and their esterified derivatives, wherein the dairy product or its analogue or derivative is selected from yoghurt, yoghurt drinks, yoghurt ice creams, creams (such as whipping cream, cooking cream, spoonable creams, pourable cream, coffee creamer); cream cheese, fresh cheese, creme fraiche, Kefir, Umer, quark, soured milk (karne milk), fromage frais, fromage blanc, cottage cheese, buttermilk and whey and products made from buttermilk or whey.

### DETAILED DESCRIPTION OF THE INVENTION

Food compositions according to the present invention and those resulting from use according to the present invention have been found to exhibit enhanced creaminess. Creaminess per se is a well known property of dairy type products however, the present invention seeks to enhance the creaminess of those products which already have a substantial creamy property and to add to or boost creaminess in those which have little or no creaminess. Without being bound by any theory or explanation, the applicants have conjectured that the creamy impression given by inter alia, full fat dairy products such as full fat milk, cream and dairy ice cream is at least partly due to the presence of milk fat globules comprising a butterfat and protein complex structure. It is therefore surprising that this perception can be endowed or enhanced by creaminess enhancers as herein defined.

The Dairy Product, Derivative or Analogue

As used herein, the term dairy product means a product consisting of, or adapted only slightly from, the naturally occurring source (e.g. milk, skimmed milk etc.). Reference to a dairy product derivative means a processed dairy product such as yoghurt. A dairy product analogue is one where all or a major part of the naturally occurring animal product is replaced by a vegetable fat or non-fat animal product such as protein, or synthetic substitute of any of these, and mixtures thereof.

The dairy product may for example be milk or milk with a reduced fat content such as skimmed milk or semi-skimmed milk. As used herein, the term “milk” refers to cow's milk, sheep milk, goat milk or the like and derivatives thereof should be construed likewise.

Other dairy products or dairy product derivatives or analogues suitable for use in the present invention include yoghurt, yoghurt drinks, yoghurt ice creams, creams (such as whipping cream, cooking cream, spoonable creams, pourable cream, coffee creamer); cream cheese, fresh cheese, creme fraiche, Kefir, Umer, quark, soured milk (karne milk), fromage frais, fromage blanc, cottage cheese, buttermilk and whey and products made from buttermilk or whey.

The product may also be any of the foregoing, wherein the dairy fat content is partly or wholly replaced by vegetable fat.

The primary product will constitute all of the final composition other than the creaminess enhancer, emulsifier (where applicable) and optional other ingredients, for example as described further hereinbelow. Typically, it will comprise from 40% to 99.99%, preferably from 70% to 99.5%, more preferably from 50% to 95% by weight of the total composition. Preferred primary products have a fat content of from 0.01% to 0%, for example from 0.2% to 10%, more preferably from 0.5% to 2% by weight.

One particular class of embodiments according to a fourth aspect of the invention provides a milk drink composition comprising a creaminess enhancer selected from one or more of phytosterols, phytostanols, synthetic analogues thereof and the esterified derivatives of any of the foregoing, provided that the creaminess enhancer comprises at least one compound other than a stanol ester.

A milk drink composition according to the fourth aspect of the present invention preferably has a creaminess enhancer component other than a stanol ester which comprises up to 100% by weight of the total creaminess enhancer but preferably at least 10%, more preferably at least 15% by weight, especially at least 20% by weight and most preferably at least 50% by weight of the total creaminess enhancer. Sterol esters are especially preferred as constituting at least 50% by weight, most preferably substantially all of the at least creaminess enhancer component other than a stanol ester.

Preferred milk drink compositions comprise at least 75%, more preferably at least 85%, most preferably at lest 90%, especially at least 95% by weight of one or more of milk, semi-skim milk, skim milk and low fat milk.

Milk drinks include milk (with creaminess enhancer additive) milk shakes and other milk based drinks.

Another class of embodiments according to a fifth aspect of the invention provides a yoghurt drink composition comprising a creaminess enhancer selected from one or more of phytosterols, phytostanols, synthetic analogues thereof and the esterified derivatives of any of the foregoing.

A yoghurt drink composition according to the fifth aspect of the present invention preferably has a viscosity of no more than 2,000 mPas, more preferably no more than 1,500 mPas, still more preferably no more than 1,000 mPas at 25° C. at a shear rate of 21 s⁻¹.

Such yoghurt drinks may contain one or more flavouring agents such as vanilla, chocolate, caramel and fruit, any of which may be provided as natural and/or synthetic ingredients. Fruit flavours may be incorporated as one of more of fruit concentrate, fruit pulp, fruit pieces and synthetic fruit flavourings. Typical flavouring levels are from 0.1% to 15%, preferably from 1% to 10% by weight of the composition.

The amount of creaminess enhancer in a yoghurt drink composition according to the fifth aspect of the present invention is preferably from 0.1% to 10%, preferably from 2% to 7% by weight of the composition.

Still another class of embodiments according to a sixth aspect of the invention provides a yoghurt composition comprising a creaminess enhancer selected from one or more of phytosterols, phytostanols, synthetic analogues thereof and the esterified derivatives of any of the foregoing, and from 0.1% to 20% by weight of a flavouring agent.

A yoghurt composition according to the sixth aspect of the present invention preferably contains at least 50%, preferably at least 70% and preferably up to 90% by weight of one or more of milk, semi-skim milk, skim milm and low fat milk before fermentation.

The flavouring agent in such a yoghurt may contain one or more of the flavouring agent materials recited above in respect of yoghurt drinks according to the fifth aspect of the invention.

Such a yoghurt composition may optionally contain sugar, for example in an amount from 1% to 10%, preferably from 2% to 7.5% by weight of the composition.

The total amount of creaminess enhancer in a yoghurt according to the sixth aspect of the invention is preferably from 0.1% to 5%, preferably from 1% to 3% by weight of the composition.

A milk drink composition according to the fourth aspect of the invention, a yoghurt drink composition according to the fifth aspect of the invention and a yoghurt composition according to the sixth aspect of the invention, optionally may contain one or more of stabilisers, thickeners and emulsifiers. Preferred emulsifier and thickener levels are as recited elsewhere herein.

A composition according to any of the fourth, fifth or sixth aspects of the invention may also embody the essential and/or any optional components of a composition according to the second and/or third aspect of the present invention.

The Emulsifying Agent

The emulsifying agent is an essential feature of the second and third aspects of the invention and an optional feature of other aspects of the present invention.

One or more emulsifying agents may be used. These may be selected from a wide range of emulsifiers well known in the art for use in dairy or dairy-like products. A non-exhaustive list comprises fatty acid mono- or diglycerides and their corresponding esters, lecithin, citric acid ester, lactic acid ester, polyoxysorbitan monoester, tartaric acid ester and mixtures thereof.

Some specific usable emulsifying agents are those designated E470, E471, E472, E473, E474, E475, E476 and E477.

The total amount of emulsifying agent is preferably from 0.0001% to 2%, more preferably from 0.001% to 0.5%, still more preferably from 0.01% to 0.3% by weight of the food composition.

The Creaminess Enhancer

The creaminess enhancer is selected from one or more of phytosterols, phytostanols, synthetic analogues of phytosterols and phytostanols and esterified derivatives of any of the foregoing.

The total amount of creaminess enhancer is typically incorporated in an amount of from 0.1% to 20%, preferably from 0.3% to 15%, more preferably from 0.5% to 8%, still more preferably from 0.5% to 2% by weight of the food composition.

Phytosterols, also known as plant sterols or vegetable sterols can be classified in three groups, 4-desmethylsterols, 4-monomethylsterols and 4,4′-dimethylsterols. In oils they mainly exists as free sterols and sterol esters of fatty acids although sterol glucosides and acylated sterol glucosides are also present. There are three major phytosterols namely beta-sitosterol, stigmasterol and campesterol. Schematic drawings of the components meant are as given in “Influence of Processing on Sterols of Edible Vegetable Oils”, S. P. Kochhar; Prog. Lipid Res. 22:pp. 161-188.

The phytostanols are the respective 5α-saturated derivatives of phytosterols such as sitostanol, campestanol and ergostanol and their derivatives.

Synthetic analogues of any of the phytosterols or phytostanols (which include chemically modified natural phytosterols or phytostanols) may be used.

Preferably the phytosterol or phytostanol is selected from the group comprising fatty acid ester of β-sitosterol, β-sitostanol, campesterol, campestanol, stigmasterol, stigmastanol and mixtures thereof.

The most preferred creaminess enhancer is a fatty acid ester of β-sitosterol or β-sitostanol.

Fatty Acid Esters

The non-esterified creaminess enhancer materials recited in the preceding section may optionally be provided in the form of one or more fatty acid esters thereof. Mixtures of esterified and non-esterified materials may also be used.

Thus, any of the phytosterols, phytostanols and their synthetic analogues used in the present invention are preferably esterified with a fatty acid. Preferably, they are esterified with one or more C₂₋₂₂ fatty acids. For the purpose of the invention the term C₂₋₂₂ fatty acid refers to any molecule comprising a C₂₋₂₂ main chain and at least one acid group. Although not preferred within the present context the C₂₋₂₂ main chain may be partially substituted or side chains may be present. Preferably, however the C₂₋₂₂ fatty acids are linear molecules comprising one or two acid group(s) as end group(s). Most preferred are linear C₈₋₂₂ fatty acids as occur in natural oils.

Suitable examples of any such fatty acids are acetic acid, propionic acid, butyric acid, caproic acid, caprylic acid, capric acid. Other suitable acids are for example citric acid, lactic acid, oxalic acid and maleic acid. Most preferred are lauric acid, palmitic acid, stearic acid, arachidic acid, behenic acid, oleic acid, cetoleic acid, erucic acid, elaidic acid, linoleic acid and linolenic acid.

When desired a mixture of fatty acids may be used for esterification of the sterols. For example, it is possible to use a naturally occurring fat or oil as a source of the fatty acid and to carry out the esterification via an interesterification reaction. Use of a natural source nearly always results in a mixture of fatty acids.

In a particular embodiment, the fatty acid mixture contains a high amount (>50%, preferably >70%, further preferred >80%) of unsaturates, whether monounsaturated fatty acids (MUFA) and/or polyunsaturated fatty acids (PUFA). This does not only provide the advantage of e.g. PUFA itself having good blood cholesterol lowering capacity, but also of the sterols esters prepared with such fatty acids.

Preferably fatty acid mixtures of sunflower, safflower, rapeseed, linseed, olive oil, linola and/or soybean are used. These are typical sources of high PUFA and/or low SAFA. Suitable esterification conditions are for example described in WO 92/19640.

Thickeners

Preferably, the food composition comprises a thickener, for example selected from xanthan gum, locust bean gum, carrageenan, pectin, guar gum, a starch and mixtures thereof.

Preferably the amount of thickener from 0.01% to 5%, more preferably from 0.1% to 2% by weight of the total food composition.

Other Optional Ingredients

The total food composition may contain one or more other optional ingredients. These may be incorporated in the primary product or in the final composition or added to any premix or in any processing stage.

The optional ingredients may for example be chosen from stabilisers, antioxidants and other preservatives, colours, flavourings, fruit concentrates, vitamins, supplements and mixtures thereof. Suitable fruit concentrates include those derived from apricot, strawberry, cherry and any combination thereof.

Processing

The creaminess enhancing agent and emulsifier (where appropriate) may be incorporated by simple admixture with the other ingredients of the final product. Alternatively they may be pre-mixed with a proportion of the total product or pre-mixed with some or all of one or more other components of the final product, or with a precursor component or components (e.g. milk in the case of yoghurt). The premix will then be admixed into the total product bulk.

The present invention will now be described by way of the following nonlimiting examples.

### EXAMPLES

In these examples, all percentages are by weight of the composition. “Sterol Ester” means ester of sunflower oil fatty acid and βsitosterol.

### Example I

### Milk

1. Formulation:

95.955% liquid skimmed milk

3.33% dairy double cream (48% fat)

0.015% xanthan gum

0.7% sterol ester

overall:

dairy fat=1.6%

other fat=0.3%

TOTAL fat=1.9%

2. Processing:

The milk is UHT processed and aseptically packed. The UHT process is effected using direct steam injection using heat exchangers.

The process utilises the following steps:

preparation of premix (where sterol ester is added)

preheat to about 80° C.

direct UHT to 148° C. for 3 seconds

flash vessel

cool to about 80° C.

homogenise at 150 bar and then 50 bar

cool further to below 20° C.

pack aseptically

### Example II

### Yoghurt

1. Formulation:

Description Quantity %

Skimmed yoghurt base 80.0000

Skimmed milk 72.8792

Milk caseinate 1.1200

Whey protein 0.8000

Skimmed milk powder 1.6000

Sterol ester 1.1000

Mono and di-glycerides 0.0008

Streptococcus thermophilus present

Lactobacillus bulgaricus present

Bifidobacterium present

Sugar 2.5000

Strawberry fruit preparation 20.0000

Strawberry pieces 6.7000

Water 5.2720

Fructose containing syrup 3.4200

Sugar 3.1000

Modified starch: acetylated distarch adipate (E1422) 0.7800

Strawberry juice concentrate 0.4800

Stabilizers: pectin (E440) and Xanthan gum (E415) 0.1000

Colouring: Fruit-and plant extract 0.0800

Acidifier: citric acid (E330) 0.0400

Natural flavouring 0.0280

2. Processing:

Add all “yoghurt base” ingredients to the milk

Pre-treatment of milk-mixture prior to addition of cultures (homogenisation, pasteurisation)

add cultures

incubation until pH 4.5 at temperature of 43° C.

cool to about 10° C.

add flavouring/fruit preparation (aseptically)

pack

transfer to cold store at about 4° C.

### Example III

### Skimmed Milk

Formulation:

0.015% carrageenan

0.7% sterol ester

balance skimmed milk

Process: as Example I

The products prepared according to Examples I, II and III were tested on a consumer panel test against corresponding controls lacking the sterol ester. The panel reported an enhanced perception of creaminess in the Examples of the invention over their respective controls.

1. A method of enhancing the creaminess of a food composition comprising a dairy product or derivative of analogue thereof, the method comprising adding to the composition, a creaminess enhancer comprising at least one compound selected from one or more of phytosterols, phytostanols, synthetic analogues thereof and esterified derivatives of any of the foregoing as a creaminess enhancer.

2. The method of claim 1, wherein the dairy product or its analogue or derivative comprises milk, milk of reduced fat content, yoghurt, yoghurt drinks, yoghurt ice creams, creams (such as whipping cream, cooking cream, spoonable creams, pourable cream, coffee creamer); cream cheese, fresh cheese, creme fraiche, Kefir, Umer, quark, soured milk (karne milk), fromage frais, fromage blanc, cottage cheese, buttermilk and whey and products made from buttermilk or whey.

3. The method of claim 1, comprising from 0.1% to 20%, preferably from 0.3% to 15%, more preferably from 0.5 to 8%, most preferably from 0.5% to 2% by weight of the total composition of the creaminess enhancer.

4. The method of claim 1, wherein the food composition further comprises an emulsifier.

5. The method of claim 4, comprising from 0.001 to 0.5%, preferably from 0.01% to 0.3% by weight of the total composition of the emulsifier.

6. A food composition comprising a dairy product or derivative or analogue thereof, from 0.001 to 0.5%, preferably from 0.01% to 0.3% by weight of emulsifier, and a creaminess enhancer selected from one or more of phytosterols, phytostanols, synthetic analogues thereof and their esterified derivatives, wherein the dairy product or its analogue or derivative is selected from yoghurt, yoghurt drinks, yoghurt ice creams, creams (such as whipping cream, cooking cream, spoonable creams, pourable cream, coffee creamer); cream cheese, fresh cheese, creme fraiche, Kefir, Umer, quark, soured milk (karne milk), fromage frais, fromage blanc, cottage cheese, buttermilk and whey and products made from buttermilk or whey.

7. The composition of claim 6, comprising from 0.1% to 20%, preferably from 0.3% to 15%, more preferably from 0.5 to 8%, most preferably from 0.5% to 2% by weight of the total composition of the creaminess enhancer.

8. A milk drink composition comprising a creaminess enhancer selected from one or more of phytosterols, phytostanols, synthetic analogues thereof and the esterified derivatives of any of the foregoing, provided that the creaminess enhancer comprises at least one compound other than a stanol ester.

9. A yoghurt drink composition comprising a creaminess enhancer selected from one or more of phytosterols, phytostanols, synthetic analogues thereof and the esterified derivatives of any of the foregoing.

10. A yoghurt composition comprising a creaminess enhancer selected from one or more of phytosterols, phytostanols, synthetic analogues thereof and the esterified derivatives of any of the foregoing, and from 0.1% to 20% by weight of a flavouring agent.
